(19) United States
(12) Patent Application Publication
(10) Pub. No.: US 2025/0180729 A1
(43) Pub. Date: Jun. 5, 2025

(54) SYSTEMS AND METHODS FOR DOPPLER GROUND SPEED SENSING

(71) Applicant: Robotic Research OpCo, LLC, Clarksburg, MD (US)

(72) Inventors: Ray Wilhelm, Gaithersburg, MD (US); Michael Rogozinski, Alexandria, VA (US); Alberto Daniel Lacaze, Potomac, MD (US); Karl Nicholas Murphy, Cocoa Beach, FL (US)

(21) Appl. No.: 18/969,672

(22) Filed: Dec. 5, 2024

Related U.S. Application Data
(60) Provisional application No. 63/606,422, filed on Dec. 5, 2023.

(51) Int. Cl. G01S 13/60; G01C 21/16; G01C 21/36; G01S 13/86

(52) U.S. Cl. CPC G01S 13/60; G01C 21/1652; G01C 21/3697; G01S 13/86

(57) ABSTRACT

A ground speed computation system for a vehicle includes ground-oriented RADAR devices, an Inertial Measurement Unit (IMU) device, a communication device, an electronic processing device in communication with the RADAR devices, the IMU device, and the communication device, and a non-transitory memory storing (i) a machine learning (ML) ground speed calculation model and (ii) instructions that when executed by the electronic processing device result in receiving, from the RADAR devices, data descriptive of a ground surface in proximity to the vehicle, receiving, from the IMU device, data descriptive of a movement of the vehicle, computing, by the ML ground speed calculation model and utilizing (i) the data descriptive of the ground surface and (ii) the data descriptive of the movement of the vehicle, to determine an estimated ground speed of the vehicle and outputting, by the communication device, an indication of the estimated ground speed of the vehicle.

### CROSS REFERENCE TO RELATED APPLICATION(S)

The application is a non-provisional of U.S. Provisional Patent Application No. 63/606,422 filed on Dec. 5, 2023 and entitled “SYSTEMS AND METHODS FOR DOPPLER GROUND SPEED SENSING,” the disclosure of which is hereby incorporated by reference herein in its entirety.

### FIELD

The present disclosure generally relates to a doppler sensing system for determining the ground speed of a vehicle.

### BACKGROUND

The speed of a vehicle has been measured in a variety of manners historically, with traditional mechanical, electro-mechanical, and/or magnetic devices being increasing replaced by electronic devices in recent times. Whether mechanical, electro-mechanical, magnetic, or electronic, most speedometers in vehicles measure movement of the vehicle's transmission and display a computed speed/velocity based on a known relationship between the transmission and the wheels/tires of the vehicle. Wheel odometry based on known wheel/tire diameters may be used to compute distance traveled, vehicle position (e.g., based on a known starting location), and/or vehicle speed (e.g., by calculating the distance traveled over a known period of time). All of the methods that rely on transmission/wheel odometry are subject to measurable errors particularly in the case that the wheel/tire diameter differs from the expected. Changes in wheel sizes, tire sizes, tire inflation levels, traction, etc., may all leas to errors with the odometry calculations.

In recent years, vehicle speed/velocity has been calculated using Global Positioning System (GPS) telemetry data that provides a measure of distance over time or using a ground-facing radar that measures the doppler shift of the signal to calculate a speed reading. GPS solutions require very good signal reception and are subject to signal inference. Doppler radar solutions are typically noisy and are subject to large variations due to topographical changes, particularly within the discrete samples used for the calculations.

### SUMMARY

Systems, apparatus, methods, and articles of manufacture for improved doppler ground speed sensing systems and platforms are provided.

In accordance with one illustrative embodiment of the present invention, a ground speed computation system for a vehicle comprises a plurality of ground-oriented RADAR devices, at least one Inertial Measurement Unit (IMU) device, a communication device, an electronic processing device in communication with the plurality of ground-oriented RADAR devices, the at least one IMU device, and the communication device, and a non-transitory memory storing (i) a machine learning (ML) ground speed calculation model and (ii) instructions that when executed by the electronic processing device result in receiving, from the plurality of ground-oriented RADAR devices, data descriptive of at least one ground surface in proximity to the vehicle, receiving, from the at least one IMU device, data descriptive of a movement of the vehicle, computing, by the ML ground speed calculation model and utilizing (i) the data descriptive of the at least one ground surface in proximity to the vehicle and (ii) the data descriptive of the movement of the vehicle, to determine an estimated ground speed of the vehicle and outputting, by the communication device, an indication of the estimated ground speed of the vehicle.

In embodiments, the plurality of RADAR devices are mounted relative to the vehicle.

In some embodiments, a first RADAR device of the plurality of ground-oriented RADAR devices is oriented in a first direction relative to the vehicle and a second RADAR device of the plurality of ground-oriented RADAR devices is oriented in a second direction relative to the vehicle different from the first direction.

In certain embodiments, the plurality of ground-oriented RADAR devices are configured to receive data descriptive of at least one of a ground surface, a ground feature, a static object or a moving object.

In other embodiments, the at least one IMU device comprises one or more Micro-Electro-Mechanical Systems (MEMS) gyroscope and/or Fiber Optic Gyroscope (FOG) devices, magnetometers, and/or accelerometers operable to detect, measure, and/or sense one or more vehicle movement, state, and/or orientation parameters.

In embodiments, the system includes at least a first IMU device and a second IMU device.

In some embodiments, the system includes one or more secondary sensors coupled relative to the vehicle. The one or more secondary sensors are configured to collect additional data descriptive of a ground surface or ground feature.

In certain embodiments, the one or more secondary sensors include at least one of Light Detection and Ranging (LiDAR), LAser Detection and Ranging (LADAR), SOund Navigation And Ranging (SONAR), Infrared Radiation (IR), RF, ultrasound, structured light, and/or imaging device.

In other embodiments, the system includes one or more location devices coupled to the vehicle.

In accordance with one illustrative embodiment of the present invention, a method, comprises receiving, from a plurality of ground-oriented RADAR devices, data descriptive of at least one ground surface in proximity to a vehicle, receiving, from at least one Inertial Measurement Unit (IMU) device, data descriptive of movement of the vehicle, computing, with a Machine Learning (ML) ground speed calculation model and utilizing (i) the data descriptive of the at least one ground surface in proximity to the vehicle and (ii) the data descriptive of the movement of the vehicle, to determine an estimated ground speed of a vehicle and outputting, by a communication device, an indication of the estimated ground speed of the vehicle. The method is performed by at least one processor coupled to memory.

In embodiments, the method further includes transmitting with the plurality of ground-oriented RADAR devices one or more signals toward the at least one ground surface.

In some embodiments, the method includes directing a first RADAR device of the plurality of ground-oriented RADAR devices in a first direction relative to the vehicle and directing a second RADAR device of the plurality of ground-oriented RADAR devices in a second direction relative to the vehicle different from the first direction.

In certain embodiments, the at least one IMU device comprises one or more Micro-Electro-Mechanical Systems (MEMS) gyroscope and/or Fiber Optic Gyroscope (FOG) devices, magnetometers, and/or accelerometers operable to detect, measure, and/or sense one or more vehicle movement, state, and/or orientation parameters.

In other embodiments, receiving, from a plurality of ground-oriented RADAR devices, data descriptive includes capturing data descriptive of at least one of a ground surface, a ground feature, a static object or a moving object.

In embodiments, the at least one IMU device comprises one or more Micro-Electro-Mechanical Systems (MEMS) gyroscope and/or Fiber Optic Gyroscope (FOG) devices, magnetometers, and/or accelerometers operable to detect, measure, and/or sense one or more vehicle movement, state, and/or orientation parameters.

In some embodiments, at least a first IMU device and a second IMU device are provided whereby each of the first IMU device and the second IMU device is coupled relative to the vehicle.

In other embodiments, the method includes collecting with one or more secondary sensors coupled relative to the vehicle, additional data descriptive of a ground surface or ground feature.

In certain embodiments, the one or more secondary sensors include at least one of Light Detection and Ranging (LiDAR), LAser Detection and Ranging (LADAR), SOund Navigation And Ranging (SONAR), Infrared Radiation (IR), RF, ultrasound, structured light, and/or imaging device.

In embodiments, the method includes obtaining data descriptive of location with one or more location devices coupled to the vehicle, location data associated with the vehicle.

In other embodiments, the one or more location devices include one of a Global Positioning System (GPS) device, wireless signal triangulation device, or atomic clock.

In some embodiments, the method includes transmitting from the ground-oriented RADAR devices one or more signals toward the at least one ground surface. In embodiments, the at least one Inertial Measurement Unit (IMU) device comprises one or more Micro-Electro-Mechanical Systems (MEMS) gyroscope and/or Fiber Optic Gyroscope (FOG) devices, magnetometers, and/or accelerometers operable to detect, measure, and/or sense one or more vehicle movement, state, and/or orientation parameters.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

The figures depict embodiments for purposes of illustration only. One skilled in the art will readily recognize from the following description that alternative embodiments of the systems and methods illustrated herein may be employed without departing from the principles described herein, wherein:

FIG. 1 is a block diagram of a system according to some embodiments;

FIG. 2A, FIG. 2B, and FIG. 2C are a block diagram and two (2) perspective diagrams of a system according to some embodiments;

FIG. 3 is a block diagram of a processing system according to some embodiments;

FIG. 4 is a flow diagram of a method according to some embodiments;

FIG. 5 is a block diagram of an apparatus according to some embodiments; and

FIG. 6A, FIG. 6B, FIG. 6C, FIG. 6D, and FIG. 6E are perspective diagrams of exemplary data storage devices according to some embodiments.

### DETAILED DESCRIPTION

### I. Introduction

Embodiments herein solve these and/or other deficiencies of the prior art by providing systems, methods, apparatus, and/or articles of manufacture for improved doppler ground speed sensing. In some embodiments, multiple radar/Doppler returns may be analyzed to compute a more accurate ground speed (e.g., based on Doppler phenomena frequency shifting). According to some embodiments, radar return computations may be analyzed along with inertial measurement inputs (e.g., from an Inertial Measurement Unit (IMU) device) to enable long and/or stable unbiased averages to be computed. In some embodiments, Multi-Input-Multi-Output (MIMO) radar processing may be utilized. According to some embodiments, true ground-plane speed measurement may be computed by analyzing an entire downward hemisphere of radar reflections to solve for one or more ground plane parameters such as velocity (e.g., in two (2) or three (3) dimensions), height above plane, angle to plane, angle to gravity, etc.

### II. Doppler Ground Speed Sensing Systems

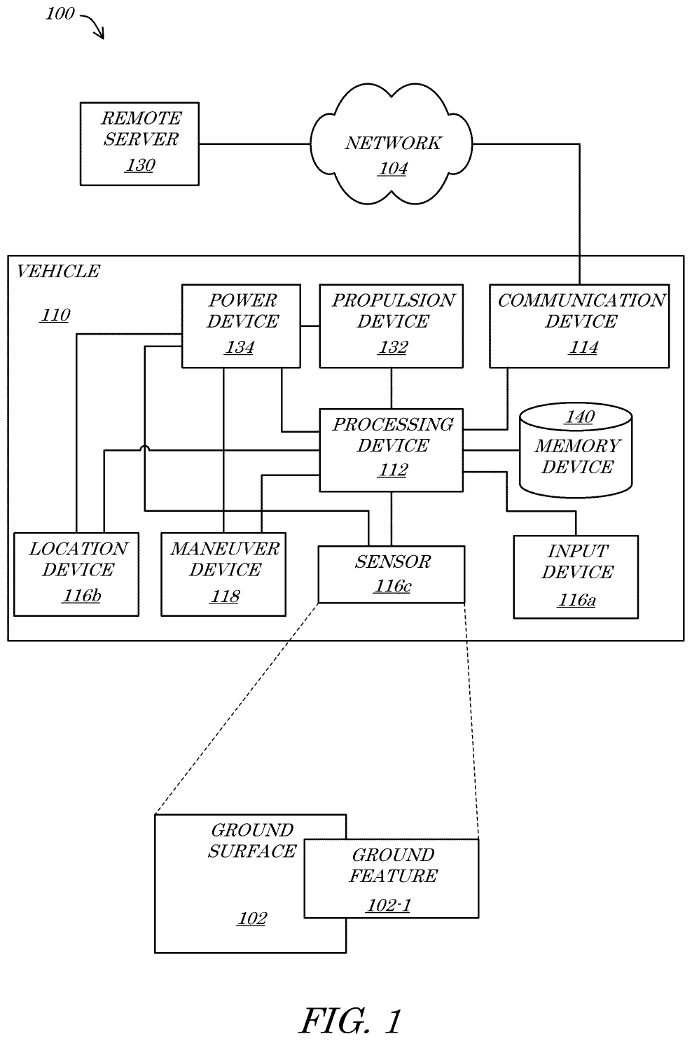

Referring first to FIG. 1, a block diagram of a system 100 according to some embodiments is shown. In some embodiments, the system 100 may comprise a ground surface 102 (e.g., comprising a ground feature 102-1), a network 104, and/or a vehicle 110. The vehicle 110 may comprise, for example, a processing device 112, a communication device 114, an input device 116a, a location device 116b, a sensor 116c, and/or a maneuver device 118. In some embodiments, the vehicle 110 may be in communication with, e.g., via the network 104, a remote server 130. According to some embodiments, the vehicle 110 may comprise a propulsion device 132, a power device 134, and/or a memory device 140.

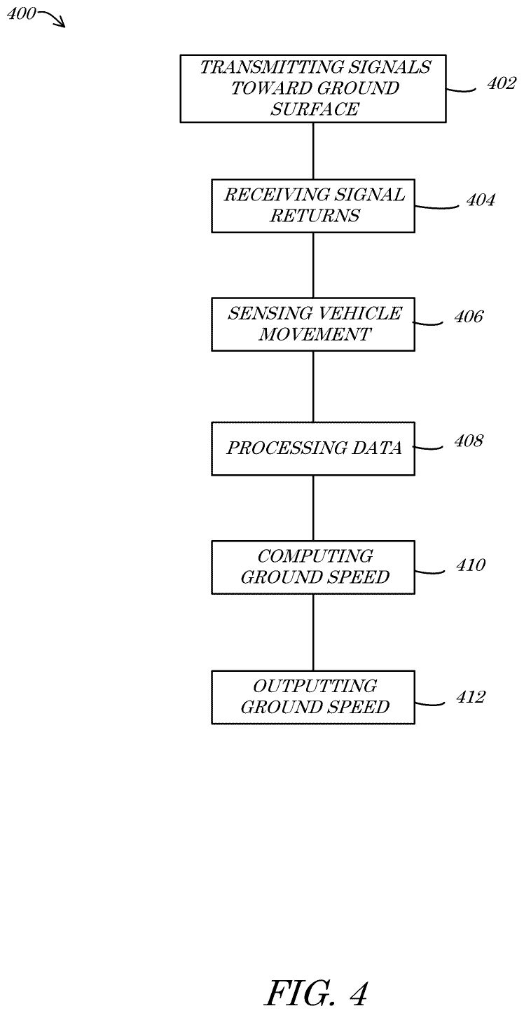

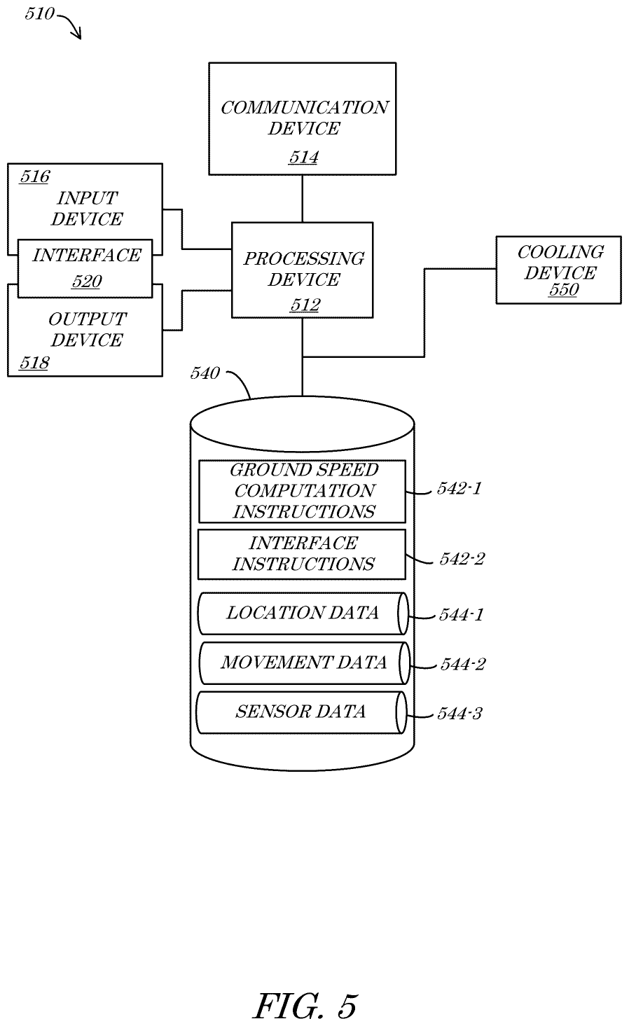

Fewer or more components 102, 102-1, 104, 110, 112, 114, 116a-c, 118, 130, 132, 134, 140 and/or various configurations of the depicted components 102, 102-1, 104, 110, 112, 114, 116a-c, 118, 130, 132, 134, 140 may be included in the system 100 without deviating from the scope of embodiments described herein. In some embodiments, the components 102, 102-1, 104, 110, 112, 114, 116a-c, 118, 130, 132, 134, 140 may be similar in configuration and/or functionality to similarly named and/or numbered components as described herein. In some embodiments, the system 100 (and/or portion thereof) may comprise an improved doppler ground speed sensing system and/or platform programmed and/or otherwise configured to execute, conduct, and/or facilitate one or more methods such as the method 400 of FIG. 4 herein, or portions thereof.

According to some embodiments, the ground surface 102 may comprise any type, configuration, and/or quantity of transportation pathways and/or areas that are or become known or desirable. The ground surface 102 may comprise, for example, one or more roads, highways, trails, and/or other paved or unpaved terrain that is traversed by the vehicle 110. According to some embodiments, the ground surface 102 may comprise various pathways (marked or unmarked; fixed or transient), parking spots, loading areas, fueling areas, obstacles, etc. In some embodiments, the ground feature 102-1 may comprise one or more terrain features such as ditches, bumps, rocks, plants, and/or markings, indentations, protrusions, curbs, speed bumps or humps, electronic tags, beacons, or transmitters, reflectors, and/or other stationary or fixed objects and/or one or more mobile and/or moving objects such as other vehicles (e.g., manned and/or autonomous), pedestrians, etc. (not shown).

The network 104 may, according to some embodiments, comprise a Local Area Network (LAN; wireless and/or wired), cellular telephone, Bluetooth®, Near Field Communication (NFC), and/or Radio Frequency (RF) network with communication links between the remote server 130 and the vehicle 110. In some embodiments, the network 104 may comprise direct communication links between any or all of the components 102, 102-1, 104, 110, 112, 114, 116a-c, 118, 130, 132, 134, 140 of the system 100. The sensor 116b may, for example, be directly interfaced or connected to one or more of the processing device 112 and/or the remote server 130 via one or more wires, cables, wireless links, and/or other network components, such network components (e.g., communication links) comprising portions of the network 104. In some embodiments, the network 104 may comprise one or many other links or network components other than those depicted in FIG. 1. The vehicle 110 may, for example, be connected to the remote server 130 via various cell towers, routers, repeaters, ports, switches, and/or other network components that comprise the Internet and/or a cellular telephone (and/or Public Switched Telephone Network (PSTN) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102, 102-1, 104, 110, 112, 114, 116a-c, 118, 130, 132, 134, 140 of the system 100. The network 104 may comprise one or more cellular telephone networks with communication links between the communication device 114 and the remote server 130, for example, and/or may comprise an NFC, RAdio Detection And Ranging (RADAR), LiDAR, and/or other short-range wireless communication path, with communication links between the vehicle 110 and the ground surface 102 (and/or ground feature 102-1), for example.

According to some embodiments, the vehicle 110 may comprise any type, configuration, and/or quantity of vehicle, manned, unmanned, autonomous, or semi-autonomous, that is or becomes known or practicable. The vehicle 110 may comprise, for example, an autonomous path-following transportation vehicle that is operable to follow one or more predefined and/or automatically computed paths along the ground surface 102 or a manned vehicle 110 that comprises the sensor 116c that facilitates safe traversal of the manned vehicle 110 along the ground surface 102. In some embodiments, the vehicle 110 may comprise the processing device 112 such as a Central Processing Unit (CPU) that executes instructions (not shown) stored in the memory device 140 to operate in accordance with embodiments described herein. The processing device 112 may, for example, execute one or more programs, modules, and/or routines that facilitate utilization of the sensor 116c to compute a speed of the vehicle 110. The processing device 112 may comprise, in some embodiments, one or more Eight-Core Intel® Xeon® 7500 Series electronic processing devices.

According to some embodiments, the communication device 114 may comprise any wired and/or wireless communication object and/or network device such as, but not limited to, a Radio Frequency (RF) antenna, transmitter, and/or receiver. In some embodiments, the communication device 114 may comprise hardware, software, and/or firmware operable to enable wireless communications including, but not limited to, encoding and/or decoding modules, filters, and/or encryption and/or decryption modules. In some embodiments, the communication device 114 may comprise one or more output devices such as buzzers, lights, alarms, vibration devices, etc. The communication device 114 may comprise, for example, a mechanical and/or electrical output device that provides ground speed output to a driver of the vehicle 110.

According to some embodiments, the input device 116a may comprise one or more of a throttle, a steering, and a brake control mechanism and/or interface via which a human operator may control the speed and/or direction of the vehicle 110 along the ground surface 102. The operator may, for example, utilize the input device 116a to define a control action to define a desired the speed of the vehicle 110 as well as to make decisions such as when to stop or to continue past, around, over, and/or under the ground feature 102-1. According to some embodiments, the input device 116a may comprise one or more switches, levers, wheels, pedals, and/or interface elements capable of communicating speed, direction, etc.

In some embodiments, the location device 116b may comprise any type, quantity, and/or configuration of location identification and/or tracking device that is or becomes known or practicable. The location device 116a may comprise, for example, one or more Global Positioning System (GPS) devices, wireless signal triangulation devices, atomic clocks, etc.

According to some embodiments, the sensor 116c may comprise may any type, configuration, and/or quantity of sensor devices that are or become known or practicable. In some embodiments, the sensor 116c may comprise a Light Detection and Ranging (LiDAR), LAser Detection and Ranging (LADAR), RADAR, SOund Navigation And Ranging (SONAR), Infrared Radiation (IR), RF, ultrasound, structured light, and/or imaging (e.g., stereo vision and/or 3-D camera) device operable to acquire data descriptive of the ground surface 102 and/or the ground feature 102-1 (e.g., rocks, terrain topography, holes, plants, pedestrians, other vehicles, static and/or dynamic objects) thereof. According to some embodiments, the sensor 116c may also or alternatively comprise a gyroscope, image, audio, and/or video capture and/or recording device, chemical detection device, and/or a light sensor. According to some embodiments, the sensor 116c may comprise various movement sensors such as speed/velocity sensors, pressure sensors, temperature sensors, accelerometers, IMU devices, and/or tilt sensors. In some embodiments, the sensor 116c may comprise a plurality of RADAR devices, Analog-to-Digital Converter (ADC) devices, micro-controllers, filters, etc. that are orientated to compute a ground speed based on readings obtained from the ground surface 102 (and/or ground feature 102-1). According to some embodiments, the sensor 116c may comprise one or more RADAR II™ ground speed measurement devices available from the DICKEY-john Corporation of Auburn, IL.

In some embodiments, the maneuver device 118 may comprise any type, quantity, and/or configuration of mechanical, electrical, and/or electro-mechanical devices that are operable to control the path of the vehicle 110. The maneuver device 118 may comprise, for example, steering linkage, actuators, control surfaces, thrust vectoring devices, etc. In some embodiments, the maneuver device 118 may be coupled to and/or in communication with the propulsion device 132. The maneuver device 118 may comprise, for example, a steer-by-wire system that permits computerized control of the maneuvering of the vehicle 110. The maneuver device 118 and the propulsion device 132 may, for example, operate in a coordinated fashion (e.g., in response to commands from the processing device 112) to cause the vehicle 110 to follow a desired path and/or route along, through, over, and/or past the ground surface 102.

According to some embodiments, the propulsion device 132 may comprise any type, configuration, and/or quantity of propulsion devices that are operable to move the vehicle 110 from one location to another. The propulsion device 132 may comprise, for example, one or more motors, engines, gears, drives, propellers, fans, jets, nozzles, wheels, treads, and/or magnetic propulsion devices. According to some embodiments, the power device 134 may be electrically coupled to provide power to any or all of the propulsion device(s) 132, the communication device 114, the processing device 112, the input device 116a, the location device 116b, the sensor 116c, and/or the maneuver device 118. In some embodiments, the power device 134 may comprise a power source such as a solar panel, inertial generator, on-board generator, alternator, fuel-cell, external power supply port, etc. According to some embodiments, the power device 134 may also or alternatively comprise a power storage device such as one or more capacitors, batteries, fuel reservoirs or tanks, etc.

In some embodiments, the memory device 140 may store various logic, code, and/or applications, each of which may, when executed, participate in, facilitate, and/or cause vehicle operation, as described herein. In some embodiments, the memory device 140 may comprise any type, configuration, and/or quantity of data storage devices that are or become known or practicable. The memory device 140 may, for example, comprise an array of optical and/or solid-state memory cards or hard drives configured to store sensor data, signal data, terrain data, object classification data, navigation data, road network data, rules of the road data, speed computation data, routing data (e.g., analysis formulas and/or mathematical models), credentialing and/or communication instructions, codes, and/or keys, and/or various operating instructions, drivers, etc. In some embodiments, the memory device 140 may comprise a solid-state and/or non-volatile memory card (e.g., a Secure Digital (SD) card, such as an SD Standard-Capacity (SDSC), an SD High-Capacity (SDHC), and/or an SD extended-Capacity (SDXC) and any various practicable form-factors, such as original, mini, and micro sizes, such as are available from Western Digital Corporation of San Jose, CA. While the memory device 140 is depicted as a stand-alone component of the vehicle 110, the memory device 140 may comprise multiple components. In some embodiments, a multi-component memory device 140 may be distributed across various devices and/or may comprise remotely dispersed components. Either of the vehicle 110 and/or the remote server 130 may comprise the memory device 140 or a portion thereof, for example.

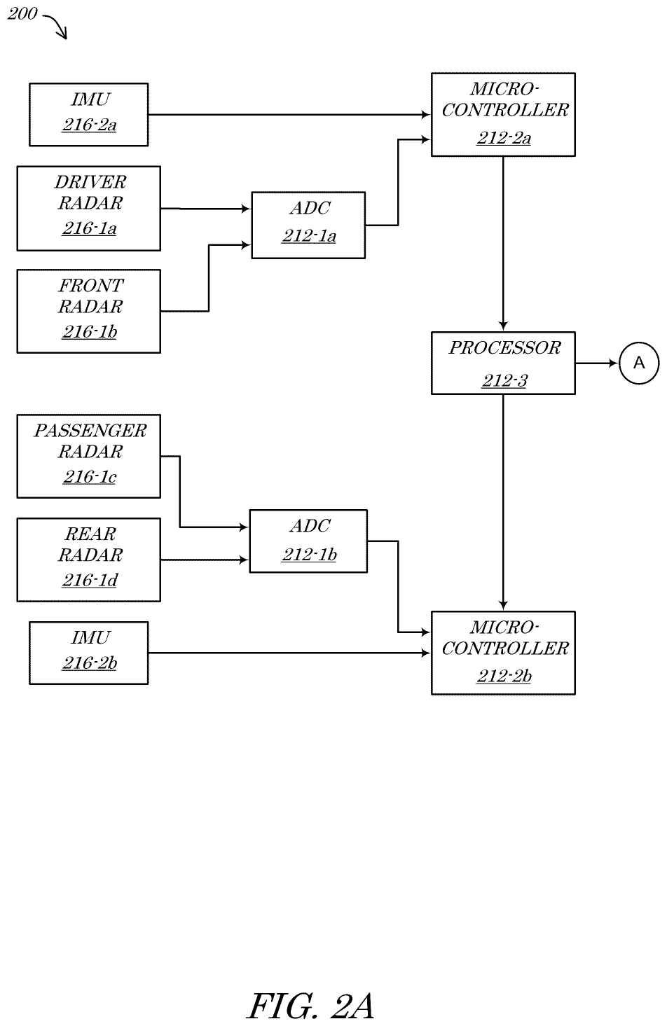

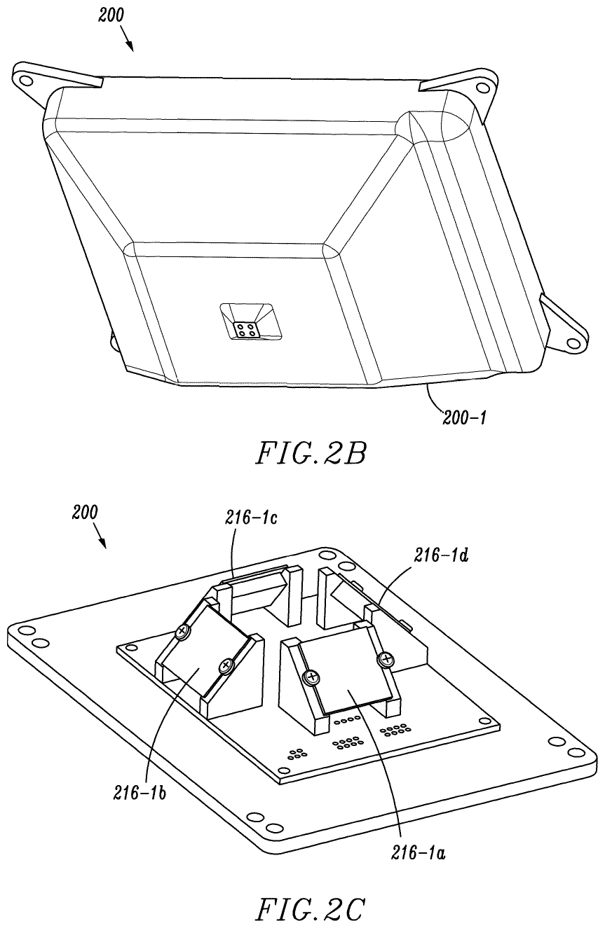

Turning to FIG. 2A, FIG. 2B, and FIG. 2C, a block diagram and two (2) perspective diagrams of a system 200 according to some embodiments is shown. In some embodiments, the system 200 may be similar in configuration and/or functionality to the system 100 of FIG. 1 herein. The system 200 may, for example, comprise a housing 200-1 (depicted in FIG. 2B), a plurality of processing devices such as one or more ADC units 212-1a, 212-1b, one or more micro-controllers 212-2a, 212-2b, and/or a processor 212-3. In some embodiments, the system 200 may comprise a plurality of RADAR units 216-1a, 216-1b, 216-1c, 216-1d (depicted in FIG. 2A and FIG. 2C) and/or a plurality of IMU units 216-2a, 216-2b that provide data readings and/or input to one or more of the plurality of processing devices 212-1a, 212-1b, 212-2a, 212-2b, 212-3.

According to some embodiments, the plurality of RADAR units 216-1a, 216-1b, 216-1c, 216-1d may comprise distinct RADAR transmitters and/or receivers (e.g., four (4) as shown for purposes of example) that are coupled to different portions of a vehicle (not shown; e.g. the vehicle 110 of FIG. 1) and/or coupled to a common housing mounted to the vehicle, and/or orientated in different directions. The RADAR units 216-1a, 216-1b, 216-1c, 216-1d may comprise, for example, one or more K-LD7™ digital RADAR transceivers available from RFbeam Microwave GmbH of Gallen, Switzerland. In some embodiments, each of the RADAR units 216-1a, 216-1b, 216-1c, 216-1d may be oriented to take readings and/or capture data descriptive of an area of ground (not shown), e.g., in front of, to the side of, and/or beneath the vehicle. The data may comprise, for example, data descriptive of an intensity/level, range, and/or an angle of a RADAR signal return. According to some embodiments, each RADAR unit 216-1a, 216-1b, 216-1c, 216-1d may be oriented to capture data descriptive of a different area of ground while in some embodiments the RADAR units 216-1a, 216-1b, 216-1c, 216-1d may be oriented such that each different area of ground comprises at least a portion of overlap with one or more adjacent different areas of ground. In some embodiments, such as labeled in FIG. 2A for purposes of non-limiting example, a first RADAR unit 216-1a may comprise a RADAR unit mounted to detect a ground area proximate to a driver side of the vehicle, a second RADAR unit 216-1b may comprise a RADAR unit mounted to detect a ground area proximate to a front of (e.g., in front of) the vehicle, a third RADAR unit 216-1c may comprise a RADAR unit mounted to detect a ground area proximate to a passenger side of the vehicle, and/or a fourth RADAR unit 216-1d may comprise a RADAR unit mounted to detect a ground area proximate to a rear of (e.g., behind) the vehicle. According to some embodiments, the RADAR unit 216-1a, 216-1b, 216-1c, 216-1d may comprise direct-conversion units that output complex signals (e.g., in-phase and/or quadrature components).

In some embodiments, the RADAR units 216-1a, 216-1b, 216-1c, 216-1d may acquire data descriptive of one or more respective ground surfaces (and/or features) and send the data to respective ADC units 212-1a, 212-1b. As depicted for purposes of non-limiting example in FIG. 2A, the first and second RADAR units 216-1a, 216-1b may provide data to a first ADC unit 212-1a and/or the third and fourth RADAR units 216-1c, 216-1d may provide data to a second ADC unit 212-1b. According to some embodiments, each ADC unit 212-1a, 212-1b may process, convert, and/or filter the data and provide output to a respective one or more of the micro-controllers 212-2a, 212-2b. As depicted for purposes of non-limiting example in FIG. 2A, the first ADC unit 212-1a and/or a first IMU unit 216-2a may provide data to a first micro-controller 212-2a and/or the second ADC unit 212-1b and/or a second IMU unit 216-2b may provide data to a second micro-controller 212-2a. In some embodiments, the IMU units 216-2a, 216-2b may be coupled to areas of the vehicle proximate to the respectively paired RADAR units 216-1a, 216-1b, 216-1c, 216-1d. The first IMU unit 216-2a may be coupled to a front and/or driver side of the vehicle, for example, and/or the second IMU unit 216-2b may be coupled to a rear and/or passenger side of the vehicle. In some embodiments, the IMU units 216-2a, 216-2b may comprise one or more STIM318™ IMU devices available from Safran of Skoppum, Norway.

According to some embodiments, the micro-controllers 212-2a, 212-2b may process, filter, convert, timestamp, organize, and/or otherwise manage the inputs from the RADAR units 216-1a, 216-1b, 216-1c, 216-1d and the IMU units 216-2a, 216-2b. In some embodiments, the micro-controllers 212-2a, 212-2b may provide the data outputs to the processor 212-3. In some embodiments, the data may be transmitted to the processor 212-3 as one or more unconfirmed transmissions such as in accordance with a User Datagram Protocol (UDP) such as Request for Comments (RFC) 768 published by the Internet Engineering Task Force (IETF) Aug. 28, 1980. In some embodiments, the processor 212-3 may execute stored instructions (not separately shown) to compute a ground speed (and/or other metric) of the vehicle based at least in part on the data captured, recorded, and/or sensed by the RADAR units 216-1a, 216-1b, 216-1c, 216-1d and the IMU units 216-2a, 216-2b. In some embodiments, the processor 212-3 may output the computed ground speed (and/or other metrics) to one or more devices and/or targets at “A”, e.g., a speedometer, odometer, autonomous drive controller, User Interface (UI), etc.

Fewer or more components 212-1a, 212-1b, 212-2a, 212-2b, 212-3, 216-1a, 216-1b, 216-1c, 216-1d, 216-2a, 216-2b and/or various configurations of the depicted components 202, 202-1, 210, 260a-b, 262a-b, 264a-b, 266 may be included in the system 200 without deviating from the scope of embodiments described herein. In some embodiments, the components 212-1a, 212-1b, 212-2a, 212-2b, 212-3, 216-1a, 216-1b, 216-1c, 216-1d, 216-2a, 216-2b may be similar in configuration and/or functionality to similarly named and/or numbered components as described herein. In some embodiments, the system 200 (and/or portion thereof) may comprise an improved doppler ground speed sensing system and/or platform programmed and/or otherwise configured to execute, conduct, and/or facilitate one or more methods such as the method 400 of FIG. 4 herein, or portions thereof.

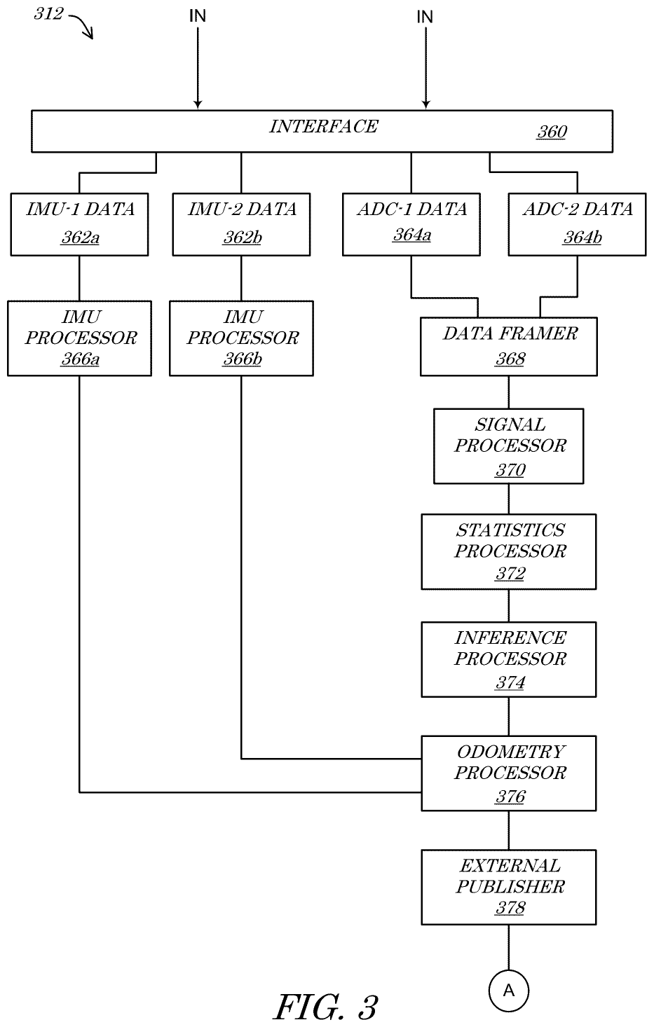

Turning to FIG. 3, a block diagram of a processing system 312 according to some embodiments is shown. In some embodiments, the processing system 312 may be similar in configuration and/or functionality to the processing device 112 and/or processor 212-3 of FIG. 1, FIG. 2A, FIG. 2B, and/or FIG. 2C herein. The processing system 312 may, for example, comprise an input interface 360 that accepts, retrieves, and/or receives a plurality of data inputs (e.g., real-time and/or stored) such as RADAR and/or IMU inputs received via one or more paths as depicted in FIG. 3. In some embodiments, the input interface 360 may receive UDP inputs and/or may direct the inputs to one or more processing modules, locations, paths, etc. As depicted in FIG. 3 for purposes of non-limiting example, IMU data 362a-b and/or ADC data 264a-b may be provided and/or output by the input interface 360. In some embodiments, the IMU data 362a-b may comprise inertial and/or other movement data descriptive of a vehicle (not shown; e.g., the vehicle 110 of FIG. 1 herein) and/or the ADC data 264a-b may comprise RADAR return data descriptive of one or more ground areas in proximity to the vehicle.

According to some embodiments, first IMU data (e.g., “IMU-1 DATA”) 362a may comprise data received from a first IMU device or devices (not shown) and/or second IMU data (e.g., “IMU-2 DATA”) 362b may comprise data received from a second IMU device or devices (also not shown). In some embodiments, each of the IMU data 362a-b data elements, signals, and/or streams may be directed (e.g., by the input interface 360) to one or more processing modules, components, and/or routines such as a first IMU processor 366a and a second IMU processor 366b, respectively. According to some embodiments, the IMU processors 366a-b may comprise processing components (hardware and/or firmware) and/or rules/logic (e.g., software, microcode, etc.) that operate upon the IMU data 362a-b data elements, signals, and/or streams to define, derive, calculate, and/or otherwise compute one or more IMU data results (not separately shown).

In some embodiments, first ADC data (e.g., “ADC-1 DATA”) 364a may comprise data received from a first ADC/RADAR device or devices (not shown) and/or second ADC data (e.g., “ADC-2 DATA”) 364b may comprise data received from a second ADC/RADAR device or devices (also not shown). In some embodiments, each of the ADC data 364a-b data elements, signals, and/or streams may be directed (e.g., by the input interface 360) to one or more processing modules, components, and/or routines such as a data framer 368, a signal processor 370, a statistics processor 372, and/or an inference processor 374. According to some embodiments, the data framer 368, the signal processor 370, the statistics processor 372, and/or the inference processor 374 may comprise processing components (hardware and/or firmware) and/or rules/logic (e.g., software, microcode, etc.) that operate upon the ADC data 364a-b data elements, signals, and/or streams to define, derive, calculate, and/or otherwise compute one or more ADC/RADAR data results (not separately shown). In some embodiments, the inference processor 374 may employ Artificial Intelligence (AI) and/or Machine Learning (ML) algorithms (e.g., a neural network model) trained to derive a ground speed measurement/result from the ADC/RADAR data results, the IMU data, historical data for similar vehicles, terrains, environmental conditions, etc., and/or from one or more additional sources such as GPS speed and/or movement data, wheel odometry data, etc.

According to some embodiments, ADC/RADAR data from the inference processor 374 and/or IMU data from the IMU processors 366a-b may be routed and/or provided to an odometry processor 376. The odometry processor 376 may comprise, in some embodiments, processing components (hardware and/or firmware) and/or rules/logic (e.g., software, microcode, etc.) that operate upon the ADC/RADAR data from the inference processor 374 and/or the IMU data from the IMU processors 366a-b to define, derive, calculate, and/or otherwise compute a ground speed (and/or other metrics) for the vehicle. In some embodiments, the ADC/RADAR data from the inference processor 374 may be utilized by the odometry processor 376 to compute the ground speed and the IMU data from the IMU processors 366a-b may be utilized to enhance the computation. According to some embodiments, other data such as wheel odometry data may be utilized to enhance the computation of the ground speed, check the computation, and/or be utilized to cap errors. In some embodiments, the general formula that may be utilized to compute the speed/velocity is:

$$V = \frac{{f}_{d} λ}{2 cos {θ}_{d}}$$

where “f_{d}” is the Doppler frequency, “λ” is the wavelength, and “θ_{d}” is the depression angle.

In some embodiments, the computed and/or calculated ground speed (and/or other metrics) may be output to and/or via one or more external and/or connected devices (not separately shown) by an external publisher 378. The external publisher 378 may, for example, format, package, encode, convert, and/or transmit the computed ground speed to one or more external and/or connected devices, modules, and/or routines at “A”. In some embodiments, the computed ground speed and/or other metrics may be then utilized as input to drive and/or influence a navigational routine, autonomous driving routine, and/or one or more driver aids and/or interface elements such as a speedometer, Heads-Up-Display (HUD), etc.

Fewer or more components 360, 362a-b, 364a-b, 366a-b, 368, 370, 372, 374, 376, 378 and/or various configurations of the depicted components 360, 362a-b, 364a-b, 366a-b, 368, 370, 372, 374, 376, 378 may be included in the processing system 312 without deviating from the scope of embodiments described herein. In some embodiments, the components 360, 362a-b, 364a-b, 366a-b, 368, 370, 372, 374, 376, 378 may be similar in configuration and/or functionality to similarly named and/or numbered components as described herein. In some embodiments, the processing system 312 (and/or portion thereof) may comprise an improved doppler ground speed sensing system and/or platform programmed and/or otherwise configured to execute, conduct, and/or facilitate one or more methods such as the method 400 of FIG. 4 herein, or portions thereof.

### III. Doppler Ground Speed Sensing Methods

Turning to FIG. 4, a flow diagram of a method 400 according to some embodiments is shown. In some embodiments, the method 400 may comprise transmitting (e.g., via one or more sensor devices) one or more signals toward a ground surface proximate to a vehicle, at 402. One or more sensors of a vehicle may, for example, transmit the one or more signals toward the ground surface proximate to the vehicle during movement and/or maneuvering of the vehicle, e.g., to acquire data that may be utilized to determine a ground speed of the vehicle. In some embodiments, the sensors may comprise an array of transmitter antennas coupled to direct signal (e.g., waveform) energy toward the ground surface. According to some embodiments, multiple signals may be transmitted at one or more angles, intensities, and/or frequencies. In some embodiments, the signal(s) may be directed to a single area of the ground surface, different ground surface areas, or overlapping grounds surface areas. In some embodiments, the sensors may comprise RADAR and/or LiDAR sensors. In some embodiments, four (4) or more sensors comprising four (4) or more transmitting antenna and/or components may be utilized.

According to some embodiments, the method 400 may comprise receiving (e.g., by the one or more sensor devices) one or more signal returns from the ground surface, at 404. The sensors may detect, receive, and/or identify, for example, one or more signal returns from the transmitted signals. In some embodiments, one or more portions or subsets of the transmitted signals may reflect off of the ground surface and return to one or more receiving antenna of the sensors. According to some embodiments, the sensors may comprise a plurality of receiving antenna orientated to capture a Field-of-View (FoV) that encompasses the entire ground surface area to which the transmitted signals were directed (e.g. at 402). In some embodiments, four (4) or more sensors comprising four (4) or more receiving antenna, antenna array portions, and/or components may be utilized. According to some embodiments, the signal returns may comprise data defining an intensity, frequency, timing data, and/or angle of the returned signals.

In some embodiments, the method 400 may comprise sensing (e.g., by at least one IMU device) movement of the vehicle, at 406. Various attributes of vehicle movement, positioning, maneuvering, and/or state may be sensed, for example, by one or more IMU devices of the vehicle. According to some embodiments, the IMU device(s) may comprise one or more Micro-Electro-Mechanical Systems (MEMS) gyroscope and/or Fiber Optic Gyroscope (FOG) devices, magnetometers, and/or accelerometers that are operable to detect, measure, and/or sense one or more vehicle movement, state, and/or orientation parameters by measuring forces exerted upon and/or discernable from the vehicle. In some embodiments, the IMU device(s) may measure and/or report heading, attitude/pitch, and/or roll orientations and/or movements of the vehicle.

According to some embodiments, the method 400 may comprise processing (e.g., by one or more of a data framer, signal processor, and/or statistical processor) data descriptive of the movement of the vehicle and data descriptive of the one or more signal returns from the ground surface, at 408. Processing hardware, firmware, micro-code, logic, mathematical models, filters, etc. may be utilized, for example, to encode and/or decode, encrypt and/or decrypt, compress, parse, filter, convert, and/or otherwise process IMU data and/or signal (e.g., RADAR) data descriptive of movement of the vehicle. In some embodiments, the data framer may perform one or more processing actions such as, but not limited to: (i) time synchronizing the received/input data, (ii) extracting RADAR data from an ADC input feed, (iii) consolidating data elements (e.g., assembling or consolidating three (3) RADAR data input elements into a single integer value), (iv) converting data into voltage, and/or (v) creating a data frame (e.g., with a resolution and/or size of five hundred and twelve (512) units, one thousand and twenty-four (1024) units, or two thousand and forty-eight (2048) units).

In some embodiments, the signal processor may perform one or more processing actions such as, but not limited to: (i) processing the frame defined by the data framer by, e.g., transforming the data from a time domain to a frequency domain by executing a Fast Fourier Transform (FFT) and/or Power Spectral Density (PSD) algorithm and/or model, (ii) parsing the input data, (iii) executing and/or utilizing a frequency domain High-Pass Filter (HPF), and/or (iv) calculating one or more data element parameters such as a square of data element magnitudes. According to some embodiments, the statistical processor may compute one or more statistical values for each input channel from the signal processor. The statistical processor may comprise, for example, a single channel processor that computes one or more of a centroid, a mass, a standard deviation, and/or a skew for each input channel. In the case of four (4) input channels, each channel may be associated with four (4) computed outputs, for a total of sixteen (16) computed values.

In some embodiments, the method 400 may comprise computing (e.g., utilizing an Al, ML, and/or neural network model) a ground speed based on the processed data, at 410. An inference processor may, for example, utilize the data descriptive of the movement of the vehicle and the data descriptive of the one or more signal returns from the ground surface (e.g., as processed by one or more of the data framer, signal processor, and/or statistical processor) to calculate a ground speed of the vehicle. In some embodiments, the sixteen (16) values from the statistical processor may be utilized as input and fed into a trained neural network model to compute the ground speed. The neural network, Al, and/or ML model may, for example, utilize the input values and comparisons to GPS data, wheel encoder/odometry data, and/or previous data for similar terrain, similar vehicles, and/or similar environmental conditions, to check, adjust, confirm, classify, and/or derive the computed ground speed for the vehicle.

According to some embodiments, the method 400 may comprise outputting (e.g., utilizing an external publisher, an output device, and/or via an electronic communications network) data indicative of the ground speed, at 412. A communication device and/or output device such as an external publisher may be utilized, for example, to output an estimation of the vehicle's ground speed (e.g., the computed ground speed) and/or other data such as an estimated error, error correction parameters, check sums, etc. In some embodiments, any or all of this data may be transmitted and/or output to a navigation unit/controller, an autonomous drive controller, a speedometer, an odometer, and/or a UI or other data consumer device and/or entity.

In some embodiments, the method 400 may comprise and/or be embodied in a computer and/or machine language that may comprise various procedures, calls, routines, and/or actions such as may be represented by:

```
main
- UdpInterface::runFromPcapFile ∥ UdpInterface::runLive
  * UdpParser::processUdpPayload
- UdpInterface::checkParser
  * adis imuProcessor.msgCallback
    * odometryProcessor.msgCallback
  * sch imuProcessor.msgCallback
  * dataFramer.msgCallback
    * signalProcessor.msgCallback
      * statsProcessor.msgCallback
        * inferenceProcessor.msgCallback
          * odometryProcessor.msgCallback
            * externalPublisher.msgCallback
UdpParser::processUdpPayload
  ==> obj : RawImuScha6VectorPacket
  ==> daq : sch.daq
- unpack SCH-IMU
  ==> obj : RawImuAdis16VectorPacket
  ==> daq : adis.daq
- unpack ADIS-IMU
  ==> obj : RawAdc4VectorPacket
  ==> daq : adc.daq
- unpack radars
ImuProcessor
  <== RawImuAdis16VectorPacket
  ==> imueig::ImuInt
  . do-IMU-stuff
DataFramer
  <== RawAdc4VectorPacket
  == DecodedAdc4Vector
  ==> GroundFrame
  . time sync data
  . extract radar samples from adc-components
  . convert to volts
  . create a frame
SignalProcessor
  <== GroundFrame
  ==> SpectrumFrame
  - SingleChannelProcessor::processFrame
    . Execute FFT
  . Frequency Domain HPF
  . Calc Sq Mag
StatsProcessor
  <== SpectrumFrame
  ==> RadarStatisticsVector
  - SingleChannelStatsProcessor x 4
    . Scale spectrum (for units)
    . Compute statistics for frame from bins
      . centroid
      . mass
      . std
      . skew
InferenceProcessor
  <== RadarStatisticsVector
  ==> GroundSpeedRadarEstimate
  . apply frame statistics to neural network model
OdometryProcessor via Radar
  <== GroundSpeedRadarEstimate
  == Internal states
  . stationary detection
  . do-odom-stuff
OdometryProcessor via IMU
  <== imueig::ImuInt
  ==> OdometryMessage
ExternalPublisher
  <== OdometryMessage
  ==> UDP
```

### IV. Doppler Ground Speed Sensing Apparatus & Articles of Manufacture

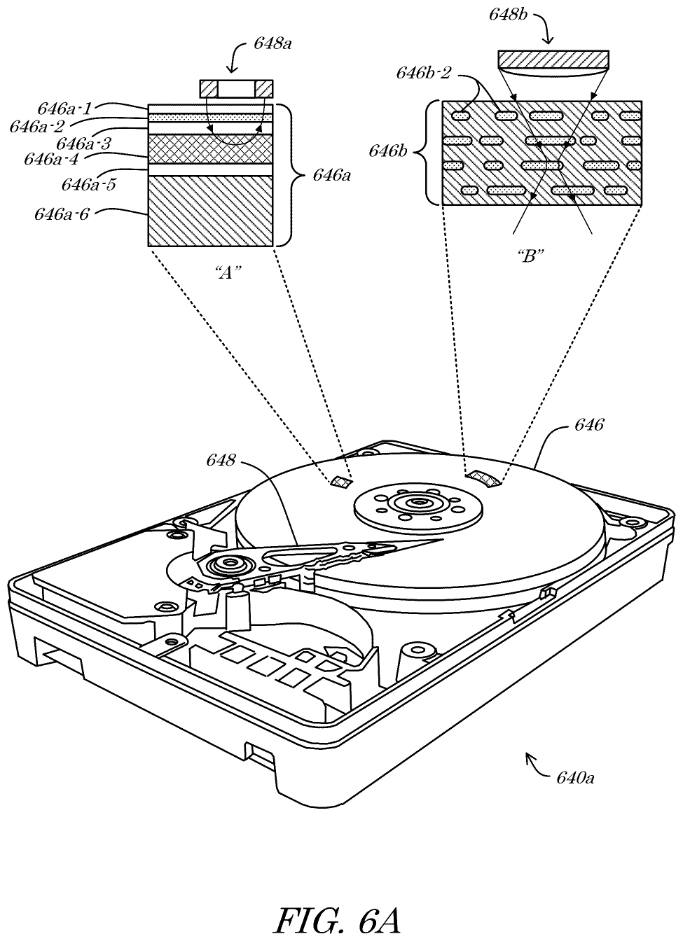

Turning to FIG. 5, a block diagram of an apparatus 510 according to some embodiments is shown. In some embodiments, the apparatus 510 may be similar in configuration and/or functionality to one or more of the vehicle 110, the processing devices 112, 212-1a, 212-1b, 212-2a, 212-2b, 212-3, 312, and/or the remote server 130, of FIG. 1, FIG. 2A, FIG. 2B, FIG. 2C, and/or FIG. 3 herein. The apparatus 510 may, for example, execute, process, facilitate, and/or otherwise be associated with an improved doppler ground speed sensing system and/or platform programmed and/or otherwise configured to execute, conduct, and/or facilitate one or more methods such as the method 400 of FIG. 4 herein, or portions thereof. In some embodiments, the apparatus 510 may comprise a processing device 512, a communication device 514, an input device 216, an output device 518, an interface 520, a memory device 540 (storing various programs and/or instructions 542 and data 544), and/or a cooling device 550. According to some embodiments, any or all of the components 512, 514, 516, 518, 520, 540, 542, 544, 550 of the apparatus 510 may be similar in configuration and/or functionality to any similarly named and/or numbered components described herein. Fewer or more components 512, 514, 516, 518, 520, 540, 542, 544, 550 and/or various configurations of the components 512, 514, 516, 518, 520, 540, 542, 544, 550 may be included in the apparatus 510 without deviating from the scope of embodiments described herein.

According to some embodiments, the processor 512 may be or include any type, quantity, and/or configuration of processor that is or becomes known. The processor 512 may comprise, for example, an Intel® IXP 2800 network processor or an Intel® XEON™ Processor coupled with an Intel® E7301 chipset. In some embodiments, the processor 512 may comprise multiple inter-connected processors, microprocessors, and/or micro-engines. According to some embodiments, the processor 512 (and/or the apparatus 510 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 510 comprises a server, such as a blade server, necessary power may be supplied via a standard AC outlet, power strip, surge protector, and/or Uninterruptible Power Supply (UPS) device.

In some embodiments, the communication device 514 may comprise any type or configuration of communication device that is or becomes known or practicable. The communication device 514 may, for example, comprise a Network Interface Card (NIC), a telephonic device, a cellular network device, a router, a hub, a modem, and/or a communications port or cable. In some embodiments, the communication device 514 may be coupled to receive RADAR and/or IMU data, e.g., from a sensor device (not separately shown in FIG. 5). The communication device 514 may, for example, comprise a BLE and/or RF receiver device and/or a camera or other imaging and/or sensing device that acquires data descriptive of a location and/or a transmitter device that provides the data to a remote server and/or server or communications layer (not separately shown in FIG. 5). According to some embodiments, the communication device 514 may also or alternatively be coupled to the processor 512. In some embodiments, the communication device 514 may comprise an IR, RF, Bluetooth™, Near-Field Communication (NFC), and/or Wi-Fi® network device coupled to facilitate communications between the processor 512 and another device (such as a remote user device, e.g., a tele-operations station, not separately shown in FIG. 5).

In some embodiments, the input device 516 and/or the output device 518 are communicatively coupled to the processor 512 (e.g., via wired and/or wireless connections and/or pathways) and they may generally comprise any types or configurations of input and output components and/or devices that are or become known, respectively. The input device 516 may comprise, for example, a knob, wheel, lever, shifter, pedal, button, switch, and/or other object that permits an operator (e.g., local or remote operator personnel) to control a speed and/or direction of the apparatus 510. In some embodiments, the input device 516 may comprise a sensor, such as a camera, sound, light, radar, RF, RADAR, and/or proximity sensor, configured to measure and/or record values via signals to the apparatus 510 and/or the processor 512. The output device 518 may, according to some embodiments, comprise a display screen and/or other practicable output component and/or device such as a sounder, light, vibration device, etc. The output device 518 may, for example, provide an interface (such as the interface 520) via which ground speed data/estimates, warnings, rules, and/or navigation data may be provided to a vehicle operator (e.g., via a mobile device application). According to some embodiments, the input device 516 and/or the output device 518 may comprise and/or be embodied in a single device, such as a touch-screen monitor.

The memory device 540 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 540 may, according to some embodiments, store one or more of ground speed computation instructions 542-1 and/or interface instructions 542-2, location data 544-1, movement data 544-2, and/or sensor data 544-3. In some embodiments, the ground speed computation instructions 542-1 and/or interface instructions 542-2, location data 544-1, movement data 544-2, and/or sensor data 544-3 may be utilized by the processor 512 to provide output information via the output device 518 and/or the communication device 514.

According to some embodiments, the ground speed computation instructions 542-1 may be operable to cause the processor 512 to process the location data 544-1, movement data 544-2, and/or sensor data 544-3 in accordance with embodiments as described herein. Location data 544-1, movement data 544-2, and/or sensor data 544-3 received via the input device 516 and/or the communication device 514 may, for example, be analyzed, sorted, filtered, decoded, decompressed, ranked, scored, plotted, and/or otherwise processed by the processor 512 in accordance with the ground speed computation instructions 542-1. In some embodiments, location data 544-1, movement data 544-2, and/or sensor data 544-3 may be fed by the processor 512 through one or more mathematical and/or statistical formulas and/or models in accordance with the ground speed computation instructions 542-1, e.g., an Al, ML, and/or neural network processing model and/or routine trained to compute a ground speed for the apparatus 510 based on multiple RADAR data elements, IMU data elements, and/or utilizing comparative logic and data classification routines for similar previous computations, as described herein.

In some embodiments, the interface instructions 542-2 may be operable to cause the processor 512 to process the location data 544-1, movement data 544-2, and/or sensor data 544-3 in accordance with embodiments as described herein. Location data 544-1, movement data 544-2, and/or sensor data 544-3 received via the input device 516 and/or the communication device 514 may, for example, be analyzed, sorted, filtered, decoded, decompressed, ranked, scored, plotted, and/or otherwise processed by the processor 512 in accordance with the interface instructions 542-2. In some embodiments, location data 544-1, movement data 544-2, and/or sensor data 544-3 may be fed by the processor 512 through one or more mathematical and/or statistical formulas and/or models in accordance with the interface instructions 542-2 to provide ground speed computations and/or estimations to an operator, a navigation systems, and/or an autonomous drive controller, as described herein.

According to some embodiments, the apparatus 510 may comprise the cooling device 550. According to some embodiments, the cooling device 550 may be coupled (physically, thermally, and/or electrically) to the processor 512 and/or to the memory device 540. The cooling device 550 may, for example, comprise a fan, heat sink, heat pipe, radiator, cold plate, and/or other cooling component or device or combinations thereof, configured to remove heat from portions or components of the apparatus 510.

Any or all of the exemplary instructions and data types described herein and other practicable types of data may be stored in any number, type, and/or configuration of memory devices that is or becomes known. The memory device 540 may, for example, comprise one or more data tables or files, databases, table spaces, registers, and/or other storage structures. In some embodiments, multiple databases and/or storage structures (and/or multiple memory devices 540) may be utilized to store information associated with the apparatus 510. According to some embodiments, the memory device 540 may be incorporated into and/or otherwise coupled to the apparatus 510 (e.g., as shown) or may simply be accessible to the apparatus 510 (e.g., externally located and/or situated).

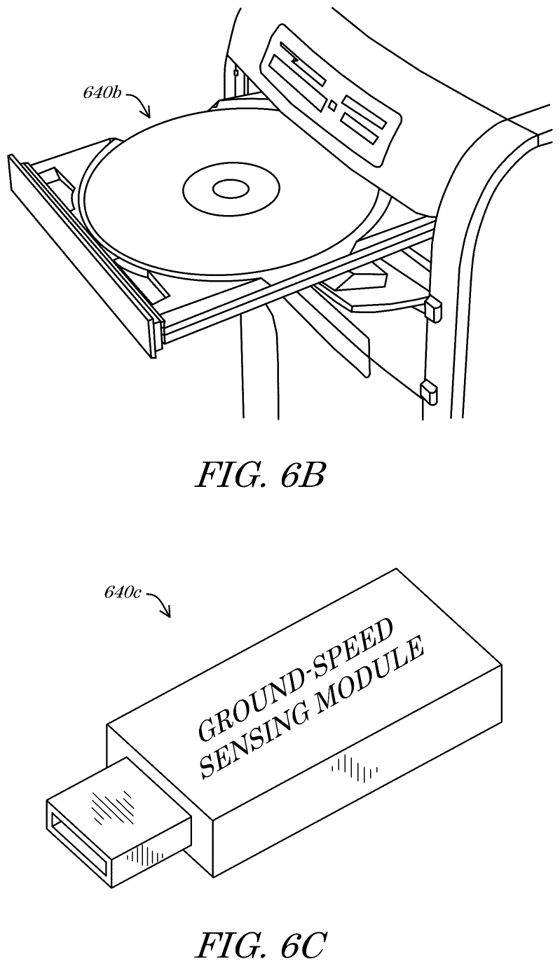

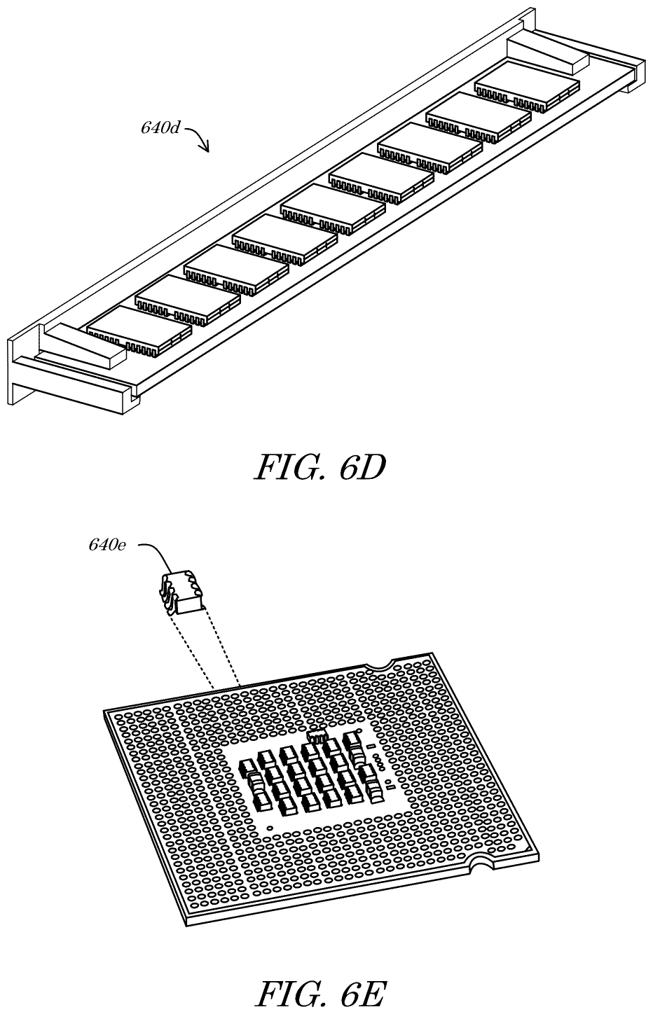

Referring to FIG. 6A, FIG. 6B, FIG. 6C, FIG. 6D, and FIG. 6E, perspective diagrams of exemplary data storage devices 640a-e according to some embodiments are shown. The data storage devices 640a-e may, for example, be utilized to store instructions and/or data such as the ground speed computation instructions 542-1 and/or interface instructions 542-2, location data 544-1, movement data 544-2, and/or sensor data 544-3, each of which is presented in reference to FIG. 5 herein. In some embodiments, instructions stored on the data storage devices 640a-e may, when executed by a processor, cause the implementation of and/or facilitate a method in accordance with embodiments herein.

According to some embodiments, the first data storage device 640a may comprise one or more various types of internal and/or external hard drives. The first data storage device 640a may, for example, comprise a data storage medium 646 that is read, interrogated, and/or otherwise communicatively coupled to and/or via a disk reading device 648. In some embodiments, the first data storage device 640a and/or the data storage medium 646 may be configured to store information utilizing one or more magnetic, inductive, and/or optical means (e.g., magnetic, inductive, and/or optical-encoding). The data storage medium 646, depicted as a first data storage medium 646a for example (e.g., breakout cross-section “A”), may comprise one or more of a polymer layer 646a-1, a magnetic data storage layer 646a-2, a non-magnetic layer 646a-6, a magnetic base layer 646a-4, a contact layer 646a-5, and/or a substrate layer 646a-6. According to some embodiments, a magnetic read head 648a may be coupled and/or disposed to read data from the magnetic data storage layer 646a-2.

In some embodiments, the data storage medium 646, depicted as a second data storage medium 646b for example (e.g., breakout cross-section “B”), may comprise a plurality of data points 646b-2 disposed with the second data storage medium 646b. The data points 646b-2 may, in some embodiments, be read and/or otherwise interfaced with via a laser-enabled read head 648b disposed and/or coupled to direct a laser beam through the second data storage medium 646b.

In some embodiments, the second data storage device 640b may comprise a CD, CD-ROM, DVD, Blu-Ray™ Disc, and/or other type of optically-encoded disk and/or other storage medium that is or becomes know or practicable. In some embodiments, the third data storage device 640c may comprise a USB keyfob, dongle, and/or other type of flash memory data storage device that is or becomes know or practicable. In some embodiments, the fourth data storage device 640d may comprise RAM of any type, quantity, and/or configuration that is or becomes practicable and/or desirable. In some embodiments, the fourth data storage device 640d may comprise an off-chip cache such as a Level 2 (L2) cache memory device. According to some embodiments, the fifth data storage device 640e may comprise an on-chip memory device such as a Level 1 (L1) cache memory device.

The data storage devices 640a-e depicted in FIG. 6A, FIG. 6B, FIG. 6C, FIG. 6D, and FIG. 6E are representative of a class and/or subset of computer-readable media that are defined herein as “computer-readable memory” (e.g., non-transitory memory devices as opposed to transmission devices or media). The data storage devices 640a-e may generally store program instructions, algorithms, software engines, code, and/or modules that, when executed by a processing device cause a particular machine to function in accordance with one or more embodiments described herein.

### V. Additional Exemplative Embodiments

[n view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

In accordance with an aspect, a ground speed computation system for a vehicle comprises a plurality of ground-oriented RADAR devices, at least one Inertial Measurement Unit (IMU) device, a communication device, an electronic processing device in communication with the plurality of ground-oriented RADAR devices, the at least one IMU device, and the communication device, and a non-transitory memory storing (i) a machine learning (ML) ground speed calculation model and (ii) instructions that when executed by the electronic processing device result in receiving, from the plurality of ground-oriented RADAR devices, data descriptive of at least one ground surface in proximity to the vehicle, receiving, from the at least one IMU device, data descriptive of a movement of the vehicle, computing, by the ML ground speed calculation model and utilizing (i) the data descriptive of the at least one ground surface in proximity to the vehicle and (ii) the data descriptive of the movement of the vehicle, to determine an estimated ground speed of the vehicle and outputting, by the communication device, an indication of the estimated ground speed of the vehicle.

In aspects, the plurality of RADAR devices are mounted relative to the vehicle.

In some aspects, a first RADAR device of the plurality of ground-oriented RADAR devices is oriented in a first direction relative to the vehicle and a second RADAR device of the plurality of ground-oriented RADAR devices is oriented in a second direction relative to the vehicle different from the first direction.

In certain aspects, the plurality of ground-oriented RADAR devices are configured to receive data descriptive of at least one of a ground surface, a ground feature, a static object or a moving object.

In other aspects, the at least one IMU device comprises one or more Micro-Electro-Mechanical Systems (MEMS) gyroscope and/or Fiber Optic Gyroscope (FOG) devices, magnetometers, and/or accelerometers operable to detect, measure, and/or sense one or more vehicle movement, state, and/or orientation parameters.

In aspects, the system includes at least a first IMU device and a second IMU device.

In some aspects, the system includes one or more secondary sensors coupled relative to the vehicle. The one or more secondary sensors are configured to collect additional data descriptive of a ground surface or ground feature.

In certain aspects, the one or more secondary sensors include at least one of Light Detection and Ranging (LiDAR), LAser Detection and Ranging (LADAR), SOund Navigation And Ranging (SONAR), Infrared Radiation (IR), RF, ultrasound, structured light, and/or imaging device.

In other aspects, the system includes one or more location devices coupled to the vehicle.

In accordance with one illustrative aspect, a method comprises receiving, from a plurality of ground-oriented RADAR devices, data descriptive of at least one ground surface in proximity to a vehicle, receiving, from at least one Inertial Measurement Unit (IMU) device, data descriptive of movement of the vehicle, computing, with a Machine Learning (ML) ground speed calculation model and utilizing (i) the data descriptive of the at least one ground surface in proximity to the vehicle and (ii) the data descriptive of the movement of the vehicle, to determine an estimated ground speed of a vehicle and outputting, by a communication device, an indication of the estimated ground speed of the vehicle. The method is performed by at least one processor coupled to memory.

In aspects, the method further includes transmitting with the plurality of ground-oriented RADAR devices one or more signals toward the at least one ground surface.

In some aspects, the method includes directing a first RADAR device of the plurality of ground-oriented RADAR devices in a first direction relative to the vehicle and directing a second RADAR device of the plurality of ground-oriented RADAR devices in a second direction relative to the vehicle different from the first direction.

In certain aspects, the at least one IMU device comprises one or more Micro-Electro-Mechanical Systems (MEMS) gyroscope and/or Fiber Optic Gyroscope (FOG) devices, magnetometers, and/or accelerometers operable to detect, measure, and/or sense one or more vehicle movement, state, and/or orientation parameters.

In other aspects, receiving, from a plurality of ground-oriented RADAR devices, data descriptive includes capturing data descriptive of at least one of a ground surface, a ground feature, a static object or a moving object.

In aspects, the at least one IMU device comprises one or more Micro-Electro-Mechanical Systems (MEMS) gyroscope and/or Fiber Optic Gyroscope (FOG) devices, magnetometers, and/or accelerometers operable to detect, measure, and/or sense one or more vehicle movement, state, and/or orientation parameters.

In some aspects, at least a first IMU device and a second IMU device are provided whereby each of the first IMU device and the second IMU device is coupled relative to the vehicle.

In other aspects, the method includes collecting with one or more secondary sensors coupled relative to the vehicle, additional data descriptive of a ground surface or ground feature.

In certain aspects, the one or more secondary sensors include at least one of Light Detection and Ranging (LiDAR), LAser Detection and Ranging (LADAR), SOund Navigation And Ranging (SONAR), Infrared Radiation (IR), RF, ultrasound, structured light, and/or imaging device.

In aspects, the method includes obtaining data descriptive of location with one or more location devices coupled to the vehicle, location data associated with the vehicle.

In other aspects, the one or more location devices include one of a Global Positioning System (GPS) device, wireless signal triangulation device, or atomic clock.

In some aspects, the method includes transmitting from the ground-oriented RADAR devices one or more signals toward the at least one ground surface. In embodiments, the at least one Inertial Measurement Unit (IMU) device comprises one or more Micro-Electro-Mechanical Systems (MEMS) gyroscope and/or Fiber Optic Gyroscope (FOG) devices, magnetometers, and/or accelerometers operable to detect, measure, and/or sense one or more vehicle movement, state, and/or orientation parameters.

### VI. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only, and are not to be taken as limiting the disclosure in any way.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

The indefinite articles “a” and “an,” as used herein in the specification and in the claims, unless clearly indicated to the contrary, should be understood to mean “at least one” or “one or more”.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As utilized herein, the terms “program” or “computer program” may refer to one or more algorithms formatted for execution by a computer. The term “module” or “software module” refers to any number of algorithms and/or programs that are written to achieve a particular output and/or output goal e.g., a ‘login credentialing’ module (or program) may provide functionality for permitting a user to login to a computer software and/or hardware resource and/or a ‘shipping’ module (or program) may be programmed to electronically initiate a shipment of an object via a known and/or available shipping company and/or service (e.g., FedEX®). The terms “engine” or “software engine” refer to any combination of software modules and/or algorithms that operate upon one or more inputs to define one or more outputs in an ongoing, cyclical, repetitive, and/or loop fashion. Data transformation scripts and/or algorithms that query data from a data source, transform the data, and load the transformed data into a target data repository may be termed ‘data transformation engines’, for example, as they repetitively operate in an iterative manner upon each row of data to produce the desired results.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

1. A ground speed computation system for a vehicle, comprising:
a plurality of ground-oriented RADAR devices;
at least one Inertial Measurement Unit (IMU) device;
a communication device;
an electronic processing device in communication with the plurality of ground-oriented RADAR devices, the at least one IMU device, and the communication device; and
a non-transitory memory storing (i) a machine learning (ML) ground speed calculation model and (ii) instructions that when executed by the electronic processing device result in:
receiving, from the plurality of ground-oriented RADAR devices, data descriptive of at least one ground surface in proximity to the vehicle;
receiving, from the at least one IMU device, data descriptive of a movement of the vehicle;
computing, by the ML ground speed calculation model and utilizing (i) the data descriptive of the at least one ground surface in proximity to the vehicle and (ii) the data descriptive of the movement of the vehicle, to determine an estimated ground speed of the vehicle; and
outputting, by the communication device, an indication of the estimated ground speed of the vehicle.

2. The system according to claim 1, wherein the plurality of RADAR devices are mounted relative to the vehicle.

3. The system according to claim 2, including a first RADAR device of the plurality of ground-oriented RADAR devices oriented in a first direction relative to the vehicle and a second RADAR device of the plurality of ground-oriented RADAR devices oriented in a second direction relative to the vehicle different from the first direction.

4. The system according to claim 1, wherein the plurality of ground-oriented RADAR devices are configured to receive data descriptive of at least one of a ground surface, a ground feature, a static object or a moving object.

5. The system according to claim 1, wherein the at least one IMU device comprises one or more Micro-Electro-Mechanical Systems (MEMS) gyroscope and/or Fiber Optic Gyroscope (FOG) devices, magnetometers, and/or accelerometers operable to detect, measure, and/or sense one or more vehicle movement, state, and/or orientation parameters.

6. The system according to claim 5, including at least a first IMU device and a second IMU device.

7. The system according to claim 1, further including one or more secondary sensors coupled relative to the vehicle, the one or more secondary sensors configured to collect additional data descriptive of a ground surface or ground feature.

8. The system according to claim 7, wherein the one or more secondary sensors include at least one of Light Detection and Ranging (LiDAR), LAser Detection and Ranging (LADAR), SOund Navigation And Ranging (SONAR), Infrared Radiation (IR), RF, ultrasound, structured light, and/or imaging device.

9. The system according to claim 1, including one or more location devices coupled to the vehicle.

10. A method, comprising:
receiving, from a plurality of ground-oriented RADAR devices, data descriptive of at least one ground surface in proximity to a vehicle;
receiving, from at least one Inertial Measurement Unit (IMU) device, data descriptive of movement of the vehicle;
computing, with a Machine Learning (ML) ground speed calculation model and utilizing (i) the data descriptive of the at least one ground surface in proximity to the vehicle and (ii) the data descriptive of the movement of the vehicle, to determine an estimated ground speed of a vehicle; and
outputting, by a communication device, an indication of the estimated ground speed of the vehicle;
wherein the method is performed by at least one processor coupled to memory.

11. The method according to claim 10 further including transmitting with the plurality of ground-oriented RADAR devices one or more signals toward the at least one ground surface.

12. The method according to claim 10, including directing a first RADAR device of the plurality of ground-oriented RADAR devices in a first direction relative to the vehicle and directing a second RADAR device of the plurality of ground-oriented RADAR devices in a second direction relative to the vehicle different from the first direction.

13. The method according to claim 10 wherein the at least one IMU device comprises one or more Micro-Electro-Mechanical Systems (MEMS) gyroscope and/or Fiber Optic Gyroscope (FOG) devices, magnetometers, and/or accelerometers operable o detect, measure, and/or sense one or more vehicle movement, state, and/or orientation parameters.

14. The method according to claim 10, wherein receiving, from a plurality of ground-oriented RADAR devices, data descriptive includes capturing data descriptive of at least one of a ground surface, a ground feature, a static object or a moving object.

15. The method according to claim 10, wherein the at least one IMU device comprises one or more Micro-Electro-Mechanical Systems (MEMS) gyroscope and/or Fiber Optic Gyroscope (FOG) devices, magnetometers, and/or accelerometers operable to detect, measure, and/or sense one or more vehicle movement, state, and/or orientation parameters.

16. The method according to claim 15, including at least a first IMU device and a second IMU device, each of the first IMU device and the second IMU device coupled relative to the vehicle.

17. The method according to claim 10, including collecting with one or more secondary sensors coupled relative to the vehicle, additional data descriptive of a ground surface or ground feature.

18. The method according to claim 17, wherein the one or more secondary sensors include at least one of Light Detection and Ranging (LiDAR), LAser Detection and Ranging (LADAR), SOund Navigation And Ranging (SONAR), Infrared Radiation (IR), RF, ultrasound, structured light, and/or imaging device.

19. The method according to claim 10, including, obtaining data descriptive of location with one or more location devices coupled to the vehicle, location data associated with the vehicle.

20. The method according to claim 19 wherein the one or more location devices include one of a Global Positioning System (GPS) device, wireless signal triangulation device, or atomic clock.
